(19) United States
(12) Patent Application Publication
(10) Pub. No.: US 2013/0037489 A1
(43) Pub. Date: Feb. 14, 2013

(54) Method and Apparatus for Separation of Impurities from Liquid by Upflow Granular Media Filters

(71) Applicant: Hua Jiang, (US)

(72) Inventor: Hua Jiang, (US)

(21) Appl. No.: 13/569,236

(22) Filed: Aug. 8, 2012

Related U.S. Application Data
(60) Provisional application No. 61/521,914, filed on Aug. 10, 2011.

(51) Int. Cl. B01D 24/46; B03C 1/30; B01D 24/32; B01D 37/00

(52) U.S. Cl. 210/695; 210/792; 210/269; 210/280; 210/223; 210/786

(57) ABSTRACT

The present invention is a gravity continuously operating filtration system for separating impurities from liquids. The liquid flows upward through a bed of filter media in a vessel and filtered liquid (filtrate) is collected above the top of the bed. Dirtied filter media are withdrawn from the bottom of the vessel and returned to the vessel from the top. The dirtied filter media are first conveyed to a separation device by which the bulk of solids are separated from the filter media. The reject liquid from the separation device is discharged as waste. The filter media are then cleaned in a spiral wash path and are then returned back to the system. The described cleaning process is far more effective than other similar filtration systems. Majority of essential components are located outside of the vessel and are convenient to access for maintenance and inspection.

### BACKGROUND OF THE INVENTION

1. Field of the Invention

This relates to a method, an apparatus, and a system for the separation of impurities from liquid. In particular, the invention relates to an improved method and an improved apparatus to filter, but not limited to, suspended solids, from a liquid.

2. Description of the Prior Art

The conventional method to remove suspended solids from a liquid is to pass the liquid through a bed of granular media in a downward direction (i.e., from the top to the bottom.). When solids contacts with the granular media, they are retained by them and are therefore removed from the liquid. A device like this is called filter. Once the media are saturated with suspended solids, the filter must be shut down and the filtration process will be stopped to regenerate the media. This process is called backwash. The backwash process typically consists of dislodging solids by introducing a stream of air by itself or in combination with a stream of water in an opposite direction (i.e., from the bottom to the top) for a period of time (usually, a couple of minutes) and then followed by a stream of water for an additional period of time (usually, ten minutes or so). After the backwash, the filter needs to be ripened for a period of time before it can be placed back into the filtration again. The filter ripen period could take about one hour. The filtration, backwash, and filter ripen processes are repeated to make up a complete production cycle.

The disadvantage of a conventional filtration system is that the filtration process can not be continuous as the filer media has to be regenerated periodically. The normal filtration stops while the media are being regenerated. This procedure reduces the productivity of the system.

Another disadvantage of the conventional filtration system is that in order to produce clean water continuously, at least one standby unit has to be provided and turned on while the active unit is being backwashed. The installation of a standby unit increases the cost of such a system unnecessarily.

Additional disadvantage of the conventional filtration system discussed above is that a backwashing system has to be provided to perform the backwash. A typical backwashing system includes an air supply system (usually include an air compressor(s) or blower(s)), backwash water pump(s), and often backwash water supply/storage unit. The backwashing system adds extra expenses to the overall treatment system investment.

Continuous filtration devices as revealed in some prior acts addressed some of aforementioned problems. An example is a countercurrent continuous filter as described in U.S. Pat. Nos. 4,126,546 and 4,197,201 issued to Hjelmn\check{e}r and Larsson in 1978 and in 1980, respectively. In such a filter, the liquid is introduced from the bottom of a tank which containing a bed of sand and the cleaned liquid exits from the top of the tank. The dirtied sand is transported through a conduit located in the center of the tank via an air-lift pump to a washing device situated above the sand bed. A filter like this addressed some of problems associated with a conventional filter and it has been installed in commercial scale around the world. However it has its own serious drawbacks.

One major drawback of a filter described in U.S. Pat. Nos. 4,126,546 and 4,197,201 is that the washing device is inadequate for cleaning the filter media. The filter media is cleaned in a washing device which uses the filtered water as the washing fluid. The effectiveness of this process is relatively poor. The turbidity and concentration of suspended solids in the product water was high and could not meet the potable water standard established by United States Environmental Protection Agency (USEPA). For instance, the turbidity in the filter effluent was in the range of 0.1 to 0.5 nephelometric turbidity units (NTU) when such a filter described above was used to produce drinking water (Parkson Corporation, Dynasand® Continuous Upflow Granular Media Filter Brochure, available online at www.parson.com accessed on Jun. 2, 2011). The standard established by USEPA is that the turbidity in the filter effluent must be less than 0.3 NTU in 95 percent of daily samples. To produce water for safe human consumption, one must install two this kind of filters in serial as described in U.S. Pat. Nos. 6,426,005 B1 and 5,843,308 (Parkson Corporation, Product Brochure—Dynasand® D2 Advanced Continuous Backwash Filtration System Brochure, available online at www.parson.com accessed on Jun. 2, 2011). Using dual stage of such a filter as disclosed in U.S. Pat. Nos. 6,426,005 B1 and 5,843,308 severely limits its application in cases where high quality of water is required, such as potable water production, since such a system would require significantly higher investment and occupy doubled footprint.

Another drawback of a filter described in U.S. Pat. Nos. 4,126,546 and 4,197,201 is that the air-lift mechanism is insufficient to break up the binding between solids and filter media and results in elevated solid concentration in the treated water. The solids are adsorbed on the filter media and the bindings between the solids and filter media are pronounced and strong. Using a stream of air in such a filter is unable to effectively break up the binding between the solid and the filter media and therefore adequately clean the media. If the filter media are not cleaned adequately, it could lose its filtering capacity and it has to be cleaned more frequently in order to produce the water with the same quality.

Still another drawback of a filter described in U.S. Pat. Nos. 4,126,546 and 4,197,201 is that it is difficult to access the air-lift transport conduit for inspection, maintenance, or repair. The transport conduit is located centrally inside the tank. The transport conduit is subject to clogging and blockage due to the nature of the dirtied filter media. Since the transport conduit is located inside the tank which is filled with the filter media, the filter media must be evacuated before one can inspect, maintain, or repair the transport conduit which increases the downtime and requires more labor.

One additional drawback of a filter described in U.S. Pat. Nos. 4,126,546 and 4,197,201 is that localized fluidization in the filer bed is inevitable as compressed air is utilized as the driving force to transport the dirtied sand for cleaning. Although an air capture device was included, a portion of the air would inevitably escape into the tank and cause localized fluidization of the filter media. Fluidization in a filter is undesirable as it could reduce the filtration efficiency of the filter media and results in higher concentration of solids and turbidity in the effluent.

In general, a continuous-backwashing filter as disclosed in U.S. Pat. Nos. 4,126,546 and 4,197,201 is economically infeasible in its application in high quality water production such as the potable water production. Its application is limited in situations where the water quality requirement is low. Two filters must be installed in series in order to produce water which is safe for human consumption. A filter like the one disclosed in U.S. Pat. Nos. 4,126,546 and 4,197,201 is difficult to maintain and repair. Using compressed air as the means of transportation makes the system complicated. A filter like this depends on air as the transport mechanism for regeneration of the filter media which causes localized fluidization of the filter media. Similar continuous filters are also disclosed in U.S. Pat. Nos. 4,720,347, 5,277,829, and 5,746,913 issued to Berne, Ward, and Chang in 1988, 1994, and 1998, respectively. They have similar disadvantages as discussed above.

Accordingly, it is an object of the present invention to provide a continuous filtration system which utilizes the whole bed of filter media by counter-current flow, between the filter media and the liquid, for the treatment of liquid.

It is another object of the present invention to provide an improved continuous filtration system which can effectively regenerate the filter media and enhance the quality of filtrate for the treatment of liquid.

These objects will become more obvious after reading the detailed description referenced to the drawing.

### SUMMARY OF THE PRESENT INVENTION

In accordance with the present invention, there is provided a counter-current, continuous filtration system that is designed to separate impurities from liquid. The filtration system of the invention comprises a tank that is filled with filter media and the influent is supplied into a bed of filter media through a series of distribution radials from the lower part of the tank. As the influent flows upwardly through the filter media bed, the impurities are intercepted by and retained on filter media and therefore removed from the liquid. The treated liquid exits at the top of the tank. The dirtied filter media are withdrawn from the base of the tank via a transport device which is located outside the tank. The solids and filter media are subsequently separated via and a separation. The reject from the separation device is discharged as waste. The filter media are further washed using the filtrate and the cleaned filter media return back to the bed from the top.

### DESCRIPTION OF THE PREFERRED EMBODIMENT

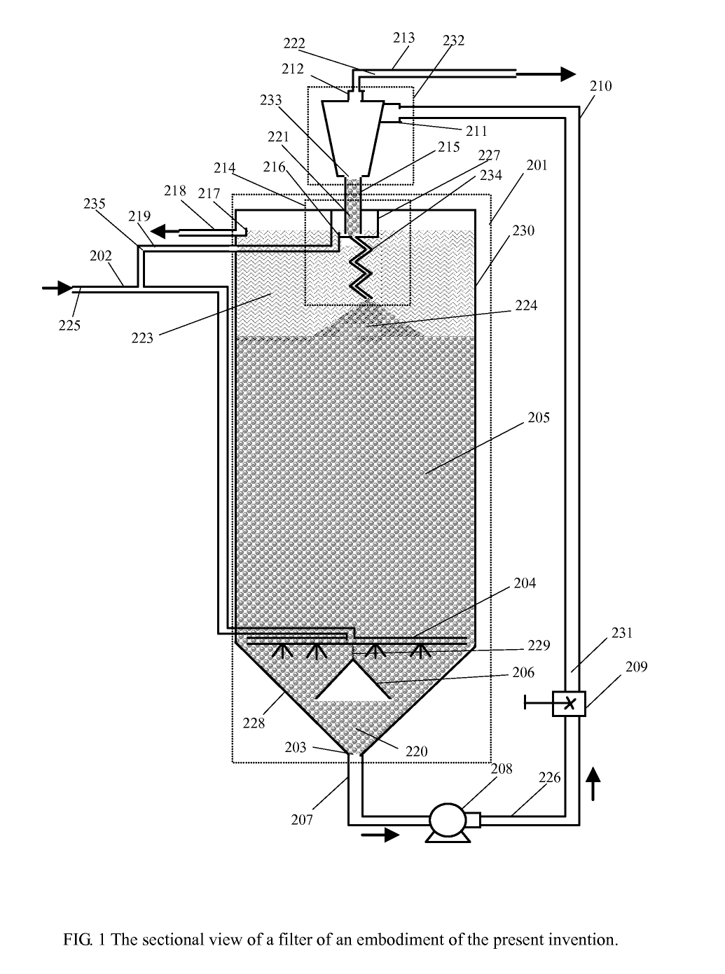

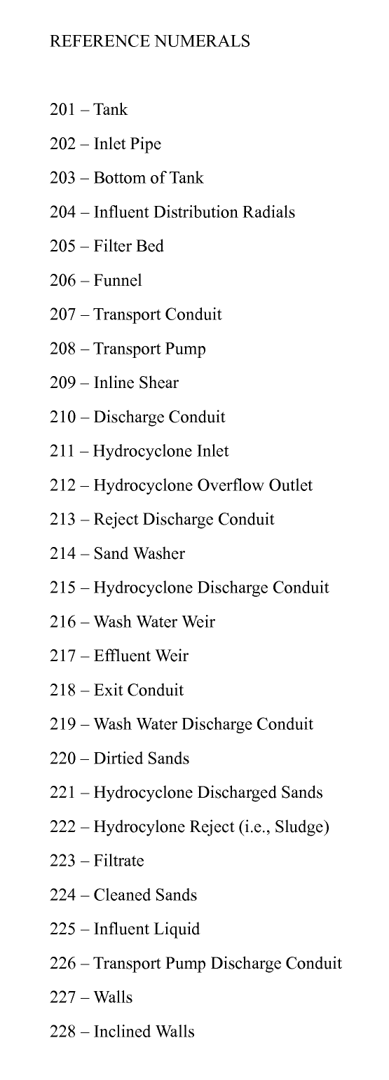

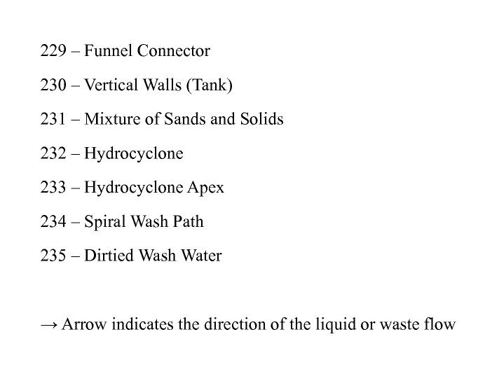

With reference to FIG. 1, a preferred embodiment of filter apparatus of this invention is presented.

A tank 201 contains a filter bed 205 consisting of loose, granular filter media, preferably of uniform grain size. The tank 201 is defined by vertical walls 230 and conical or inclined walls 228 which form a funnel-shaped bottom. The filter media can consist of e.g. sand, sand and gravel, or any granular material having an absorptive surface structure (sand is used as the filter media as illustrative purpose here). Liquid 225, which can be water or any other liquids need to be filtered, enters through an inlet pipe 202. The inlet pipe 202 connects to a series of distribution radials (the radial rack) 204 which introduces the liquid 225 into the filter bed 205. The radial rack 204 is located concentrically at the vertical base of the filter bed and it ensures the liquid 225 is equally distributed within the filter bed 205. A funnel 206 is placed upside down and is connected in the center of the series of the influent distribution radials 204 through a funnel connector 229. The funnel 206 prevents the short-circuiting of the influent liquid 225. The liquid 225 flows upwardly while the filter bed 205 moves downwardly to the base of the tank 201. Solids in the liquid 225 are effectively removed by the filter media during this counter-current movement. The filtrate (i.e., the filtered liquid) 223 exits from the top of the filter bed 205 through an effluent weir 217. The weir 217 is connected to an exit conduit 218 which transports the filtrate 223 out of the tank 201.

During the counter-current movement, the most dirtied liquid is contacted with the filter media at the vertical bottom of the filter bed 205 and the filter media sand consequently becomes most dirty. The counter-current mode of filtration takes advantages of all available filter media and is very effective. The dirtied sand 220 slides to the bottom of the tank 203 with the aid of the funnel 206. The bottom 203 is connected to a transport conduit 207. A pump 208 is connected to the transport conduit 207 to withdraw the dirtied sand 220 out of the tank 201. The solids which are bound with the sand are partially dislodged by the agitation introduced by the pump 208. The mixture of sand and solids 231 exits the pump 208 through the discharge pipe 226. The mixture of sand and solids 231 then goes through an in-line shear 209. The in-line shear 209 breaks up the binding between the solids and sand and completely dislodge the solids from the sand. The binding between the solids and sands could be strong and an extreme example of caked aggregate of solids on the filter media is often referred as mud ball. The mud ball reduces the filtrate quality by lowering the efficiency of the filter media. The life span of the filter media is also shortened by the presence of mud ball. The in-line shear effectively breaks up the binding between the solids and sands and dramatically increases the subsequent cleaning efficiency of the filter media.

The mixture of sands and solids 231 after exiting the in-line shear is conveyed to a hydrocyclone 232. In the hydrocyclone, the sands 221 and the dirtied water 222 in the mixture 231 are effectively separated under the centrifugal force. The mixture 231 enters the hydrocyclone 232 via an inlet 211 tangentially. The mixture 231 spins in the inlet 211 and the heavier sands 221 are thrown toward the wall of the chamber. The sands 221 continue on a downward spiral path to the bottom apex 233 and exit the hydrocyclone 232 via a conduit 215. The less dense fraction of the mixture, the dirtied water (hydrocyclone reject) 222, moves in the opposite direction, spiraling upward on the axis of the hydrocyclone and exits the hydrocyclone 232 through an outlet 212. It is then discharged via a reject discharge conduit 213 as waste.

The sands 221 exited the hydrocyclone 232 is further cleaned in a sand washer 214. The sands 221 arrives the upper end of the washer 214 formed by walls 227 and flows downwardly through a spiral wash path 234. The spiral wash path is submerged in the filtrate 223 in the tank 201 and hence there is a constant upward movement of the filtrate in the wash path 234. The sands 221 meets with the filtrate constantly in the counter-current motion and is cleaned once it reaches the end of the wash path 234.

The sands 221 returns back to the filter media bed 205 as cleaned filter media 224. The wash wastewater 235 exits the washer 214 through a weir 216 via a discharge conduit 219. The wash wastewater discharge conduit 219 is connected to the inlet 202. The wash water 235 is combined with the influent 225 and is recycled back to the tank 201. The weir 216 is positioned below the filtrate weir 217 and this ensures that there is a constant flow of water through the weir 216. The dirtied sand can be washed continuously or on an intermittent basis depending on circumstances.

Although a preferred embodiment of this invention has been described relative to the drawing, it should be understood that the embodiment of the invention described above are merely illustrative and other modification may be made by those skilled in the art. For example, other granular materials could be used as the filter media instead of sand as described. A magnetic separator could be used as the separation device instead of hydrocyclone when magnetite is used as the filter media. The wash wastewater could be returned to the bottom of the tank instead of returning to the influent. These and a variety of other modification may be made within the scope of the invention, which is defined by the appended claims.

What is claimed is:

1. In a method of separating impurities from a liquid by introducing said liquid upwardly across a bed of particular filter media, during which said filter media separates impurities from said liquid and becomes dirtied thereby, and thus said filtered liquid is collected above said bed, the improvement comprising cleaning the thus dirtied filter media without interrupting said filtration process by:
providing a transport device to transport filter media from a lower portion of said filter bed to a position above upper surface of said bed, therein turbulence introduced by said transport device performing the first washing of said dirtied filter media;
directing said dirtied filter media to a separation device to separate said impurities from said dirtied filter media and therein performing a further washing of said filter media by said separation device, and discharging said filter media from said separation device, such that said filter media falls downwardly toward said upper surface of said bed; and
directing said separated filter media downwardly toward said upper surface of said bed through a spiral path and performing a further washing of said filter media by means of filtered liquid, after which thus multiple-time-washed filter media falls onto said surface of said bed;
whereby said impurities will be effectively separated from said liquid, and said filter media will be effectively cleaned and returned back to said filter bed.

2. A method claimed in claim 1, wherein portion of said dirtied wash liquid is returned to said filtration process.

3. A method claimed in claim 1, comprising performing said media washing intermittently or continuously.

4. A method claimed in claim 1, wherein said separation device includes one or more of the following: a hydrocyclone or magnetic separator.

5. In an apparatus of separating impurities from a liquid by introducing said liquid upwardly across a bed of particular filter media, during which said filter media separates impurities from said liquid and becomes dirtied thereby, and thus said filtered liquid is collected above said bed, the improvement comprising cleaning thus said dirtied filter media without interrupting said filtration process by:
providing a transport device to transport said filter media from a lower portion of said filter bed to a position above upper surface of said bed, therein turbulence introduced by said transport device performing the first washing of said dirtied filter media;
directing said dirtied filter media to a separation device to separate said impurities from said dirtied filter media and therein performing a further washing of said filter media by said separation device, and discharging said filter media from said separation device, such that said filter media falls downwardly toward said upper surface of said bed; and
directing said separated filter media downwardly toward said upper surface of said bed through a spiral path and performing a further washing of said filter media by means of filtered liquid, after which thus multiple-time-washed filter media falls onto said surface of said bed;
whereby said impurities will be effectively separated from said liquid, and said filter media will be effectively cleaned and returned back to said filter bed.

6. An apparatus claimed in claim 5, wherein portion of said dirtied wash liquid is returned to the filtration process.

7. An apparatus claimed in claim 5, comprising performing said media washing intermittently or continuously.

8. An apparatus claimed in claim 5, wherein said separation device includes one or more of the following: a hydrocyclone or magnetic separator.
